(19) United States
(12) Patent Application Publication
(10) Pub. No.: US 2009/0038164 A1
(43) Pub. Date: Feb. 12, 2009

(54) BATTERY POWERED KNIFE

(75) Inventors: Marc L. Vitantonio, South Russell, OH (US); John R. Nottingham, Bratenahl, OH (US); John W. Spirk, Gates Mills, OH (US); Douglas E. Whitner, Chagrin Falls, OH (US); Brian V. Sokol, Vermilion, OH (US)

Correspondence Address: FAY SHARPE LLP, 1100 SUPERIOR AVENUE, SEVENTH FLOOR, CLEVELAND, OH, 44114, US

(73) Assignee: Innovation Direct LLC

(21) Appl. No.: 12/187,624

(22) Filed: Aug. 7, 2008

Related U.S. Application Data
(60) Provisional application No. 60/964,119, filed on Aug. 9, 2007.

(51) Int. Cl. B26B 15/00

(52) U.S. Cl. 30/277.4

(57) ABSTRACT

A battery powered dual blade knife that includes a handle having an interior cavity for containing one or more batteries. The batteries can be removably positioned at the rear portion of the handle. The cavity of the handle includes an electric motor that is generally positioned in the front region of the handle. A pair of blades is connected to the front portion of the handle and is designed to be moved relative to one another by the electric motor. The handle can be designed to waterproof one or more internal components of the knife to protect the one or more internal components from water damage. The knife can include a blade stabilization arrangement for the knife blades and/or mounts for the knife blades to facilitate in the movement of the knife blades and/or mounts for the knife blades when the motor causes the knife blades and/or mounts for the knife blades to move relative to one another. The knife can include an enhanced motor configuration in improve the operation of the knife.

The present invention claims priority on U.S. Provisional Patent Application Ser. No. 60/964,119 filed Aug. 9, 2007, which is incorporated herein by reference.

The invention relates generally to electric knives and, more particularly, to a battery-operated knife.

Electric carving knives powered by household electrical current are commonly used by consumers for cutting various food products. Various knife and battery recharging units have been proposed in the art. Although these knifes are effective in cutting various food products, these knifes typically require expensive or complex battery systems, the blades do not move fast enough relative to one another, and/or cannot be exposed to water or other liquids without concern for damaging the power supply of the knife and/or various components of the knife.

In view of the current state of the prior art for battery powered electric knifes, there is a need for a battery-powered knife that overcomes the above deficiencies related to battery powered knifes.

### SUMMARY OF THE INVENTION

The present invention is directed to an electric powered knife and more particularly to a battery-powered knife that overcomes one or more of the past deficiencies of battery powered knifes. The battery-powered knife includes a handle that has one or more interior cavities. The handle includes at least one opening that is designed to at least partially receive one or more batteries. Many different types of batteries can be used such as, but not limited to, alkaline batteries, NICAD batteries, lithium batteries, etc. The one or more batteries can be rechargeable; however, this is not required. When the one or more batteries are rechargeable, the one or more rechargeable batteries can be designed to be recharged while maintained in the handle (e.g., by connection to a power outlet, solar batteries, etc.); however, this is not required. As can be appreciated, the battery-powered knife can be at least partially powered by solar power; however, this is not required. The one or more openings in the handle for the batteries are generally located at the rear portion of the handle; however, this is not required. One or more latches and/or doors can be used to enclose the one or more batteries inside the handle; however, this is not required. The battery compartment can be designed such that a watertight seal is formed when the one or more batteries are at least partially inserted in the housing and/or the one or more latches and/or doors are closed on the one or more openings in the handle; however, this is not required. As can be appreciated, one or more portions of the handle of the knife can also include watertight seals so that other electric components in the knife (e.g., motor, electrical wires, electrical leads, etc.) and/or knife components (e.g., metal gears, metal pins, etc.) that can be damaged by liquid (e.g., water, etc.) can be protected from such liquids. The watertight or water sealing feature, when used, is designed to protect the batteries and/or other electrical components of the knife from liquid damage. The watertight feature can be designed to enable one or more portions of the knife to be immersed underwater, washed under a facet, washed in a sink and/or washed in a dishwasher without concern for damage to the batteries and/or other electrical components of the knife. As such, the watertight feature of the knife can result in the knife blades not having to be removed from the knife handle prior to the knife being rinsed off and/or washed before or after use; however, it can be appreciated that the knife blades can be removed from the knife handle prior to washing the knife handle and/or knife blades. The watertight feature can be designed to be effective even during operation of the knife. The watertight feature of the knife is an optional feature of the knife.

The front portion of the knife includes one or more openings that are designed to receive the back ends of the two knife blades. One or more of the knife blades can include one or more serrations; however, this is not required. The two knife blades can be formed of a variety of materials. One non-limiting material is metal (e.g., stainless steel, nickel alloys, etc.). The two blades are generally connected together at one or more points that are spaced from the handle of the knife; however, this is not required. The connection arrangement can be any number of arrangements (e.g., pin and slot arrangement, etc.) that enable the two knife blades to rapidly move relative to one another during the operation of the knife. The length of the knife blades is generally about 2-15 inches, and typically about 3-10 inches; however, other lengths can be used. The length of the two blades is generally the same; however, this is not required. The knife blades are generally releasably connected to the housing of the knife; however, this is not required. A quick connect/release arrangement can be used to connect and/or release the knife blades from the knife handle; however, this is not required. When used, many different arrangements can be used for the quick connect release arrangement.

An electric motor is at least partially positioned in the housing of the knife. Generally the motor is completely housing in the housing of the knife; however, this is not required. The electric motor is designed to be powered by one or more of the batteries that are positioned at least partially in the handle. As can be appreciated, the electric motor can alternatively or additionally be designed to run off of power from an electric outlet; however, this is not required. The electric motor is designed to provide the required torque and speed to the two knife blades to both a) enable the knife blades to reciprocated relative to one another at a desired speed (e.g., 200-2000 reciprocations per minute), and b) enable the knife blades to cut through a variety of food products (e.g., fruits, vegetables, meats, fish, etc.). The electric motor includes a special number of wire windings that enable the motor to generate the required speed and torque when being run off of batteries. The motor is generally positioned in the handle between the two knife blades and the one or more batteries; however, this is not required. The motor can be a reciprocating motor or a motor that engages a gear arrangement to that causes the knife blades to reciprocate relative to one another. The blades are designed to reciprocate when the electric motor is energized. The knife can include one or more triggers/switches that are used by the user to energize the electric motor. The one or more triggers/switches can be used to control the speed of the motor; however, this is not required. The one or more triggers/switches are generally located on an outside surface of the knife handle. The one or more triggers/switches are designed to directly or indirectly cause an electrical connection to be formed between the one or more batteries and the electric motor. One or more wires and/or electric circuits are generally used to assist in forming the electrical connection between the one or more batteries and the electric motor. In one non-limiting arrangement, at least one trigger/switch is designed to be movable to cause the electric motor to be energized. The one or more triggers/switches can include a watertight arrangement to inhibit or prevent water damage to the one or more triggers/switches and/or electrical components associated with the one or more triggers/switches; however, this is not required. The one or more triggers/switches can include a safety arrangement to inhibit or prevent inadvertent energization of the electric motor; however, this is not required. The electric motor, and/or electrical components associated with the electric motor can be at least partially housed in the knife such that the motor and its associated electrical components are protected by a watertight arrangement. This watertight arrangement can be formed by one or more seals and/or other types of water barriers. This watertight arrangement, when used, is designed to protect the motor and its associated electrical components from water damage. The watertight feature can be designed to enable the knife to be immersed underwater, washed under a facet, washed in a sink and/or washed in a dishwasher without concern for water damage to the motor and its associated electrical components of the knife. As such, the knife blades do not have to be removed from the knife handle prior to the knife being rinsed off and/or washed before or after use. The watertight arrangement can be designed to be effective even during operation of the knife. The watertight feature is an optional feature of the knife. As can be appreciated, the watertight arrangement, when used, can be used to at least partially protect the gearing associated with the electric motor; however, this is not required.

The knife generally includes a unique blade stabilization arrangement; however, this is not required. The blade stabilization arrangement, when used, is designed to 1) reduce the friction associated with the reciprocation of the blades by the electric motor, 2) increase the life of the knife, and/or 3) enable the battery-operated motor to reciprocate the knife blades at a desired speed. The blade stabilization arrangement includes at least one rotatable surface. The rotatable surface is generally formed by a rotatable pin or a pin that supports a surface that can rotate about the pin. The rotatable surface is designed to enable one or more of the knife blades and/or one or more knife blade supports to be at least partially supported by the rotatable surface and to move over the rotatable surface. The rotatable surface results in reduced friction to the one or more of the knife blades and/or one or more knife blade supports as the one or more of the knife blades and/or one or more knife blade supports move over the rotatable surface while the knife blades reciprocate relative to one another. In one non-limiting arrangement, at least two rotatable surfaces are used in the blade stabilization arrangement. In this non-limiting arrangement, a first rotatable surface is located above the top surface of the one or more of the knife blades and/or one or more knife blade supports and also positioned closely adjacent to the opening in the housing for the knife blades. The second rotatable surface is located below the bottom surface of the one or more of the knife blades and/or one or more knife blade supports and also positioned at a location that is spaced farther from the opening in the housing for the knife blades than the first rotatable surface. In another non-limiting arrangement, at least four rotatable surfaces are used in the blade stabilization arrangement. In this non-limiting arrangement, a first rotatable surface is located above the top surface of the one or more of the knife blades and/or one or more knife blade supports and a second rotatable surface is located below the bottom surface of the one or more of the knife blades and/or one or more knife blade supports. The first and second rotatable surfaces are both positioned closely adjacent to the opening in the housing for the knife blades. Generally, the first and second rotatable surfaces are positioned at the same distance from the opening in the housing for the knife blades; however, this is not required. The third rotatable surface is located above the top surface of the one or more of the knife blades and/or one or more knife blade supports and the fourth rotatable surface is located below the bottom surface of the one or more of the knife blades and/or one or more knife blade supports. The third and fourth rotatable surfaces are both positioned at a location that is spaced farther from the opening in the housing for the knife blades than the first and second rotatable surfaces. Generally, the third and fourth rotatable surfaces are positioned at the same distance from the opening in the housing for the knife blades; however, this is not required.

In one non-limiting arrangement, there is provided a battery powered dual blade knife that includes a handle having an interior cavity for containing one or more batteries. The batteries are generally positioned at the rear portion of the handle; however, this is not required. The one or more batteries are designed to be removable from the handle; however, this is not required. The one or more batteries can be rechargeable; however, this is not required. The cavity of the handle can include an electric motor that is generally positioned in the front region of the handle; however, this is not required. A pair of blades is connected to the front portion of the handle and is designed to be moved relative to one another by the electric motor. The one or more batteries and the motor are electrically coupled to a trigger or switch such that the motor is energized upon a user activating the trigger or switch. The handle can be designed to waterproof one or more internal components of the knife to protect the one or more internal components from water damage; however, this is not required. The knife generally includes a blade stabilization arrangement for the knife blades and/or mounts for the knife blades; however, this is not required. The blade stabilization arrangement, when used, is designed to facilitate in the movement of the knife blades and/or mounts for the knife blades when the motor causes the knife blades and/or mounts for the knife blades to move relative to one another. The knife can include an enhanced motor configuration in improve the operation of the knife: however, this is not required.

One non-limiting object of the present invention is to provide a battery-powered knife.

Another and/or alternative non-limiting object of the present invention is to provide a battery-powered knife that can cause the reciprocation of two knife blades at a desired speed and/or with the desired force so as to cut through a variety of food items.

Still another and/or alternative non-limiting object of the present invention is to provide a battery-powered knife that includes an electric motor which is energized by standard household batteries and which electric motor can cause the reciprocation of two knife blades at a desired speed and/or with the desired force so as to cut through a variety of food items.

Yet another and/or alternative non-limiting object of the present invention is to provide a battery-powered knife that includes a blade stabilization arrangement that is designed to reduce the friction associated with the reciprocation of the blades by the electric motor, increase the life of the knife, and/or enable the battery-operated motor to reciprocate the knife blades at a desired speed.

Still yet another and/or alternative non-limiting object of the present invention is to provide a battery-powered knife that includes a water sealing arrangement to enable the knife blades to be washed and/or cleaned without having to first remove the knife blades from the knife and without concern for damaging the electric motor, batteries, and/or other components of the knife.

Another and/or alternative non-limiting object of the present invention is to provide a battery-powered knife that can be operated with stand household alkaline batteries.

Still another and/or alternative non-limiting object of the present invention is to provide a battery-powered knife that has an ergonomic handle, is lightweight and/or is easy to grip and maneuver.

Yet another and/or alternative non-limiting object of the present invention is to provide a battery-powered knife that has removable and/or interchangeable reciprocating blades.

These and other objects and advantages will become apparent to those skilled in the art upon reading and following the description taken together with the accompanying drawings.

### BRIEF DESCRIPTION OF THE DRAWINGS

Reference may now be made to the drawings which illustrate various preferred embodiments that the invention may take in physical form and in certain parts and arrangement of parts wherein:

FIG. 1 is a front elevation view of one non-limiting battery-powered knife in accordance with the present invention;

FIG. 2 is a top view of the knife illustrated in FIG. 1;

FIG. 3 is a side view of the knife illustrated in FIG. 1;

FIG. 4 is one non-limiting representation of a side view of the blade stabilization arrangement that can be used in the knife of the present invention;

FIG. 5 is a top view of the blade stabilization arrangement of FIG. 5;

FIG. 6 is another non-limiting view of a blade stabilization arrangement that can be used in the knife of the present invention;

FIG. 7 is a front elevation view of another non-limiting battery-powered knife in accordance with the present invention;

FIG. 8 is a side cross-section of the battery-powered knife of FIG. 7; and,

FIG. 9 is an enlarged sectional view of the activation button of the battery-powered knife of FIG. 7.

### DETAILED DESCRIPTION OF THE PREFERRED EMBODIMENTS

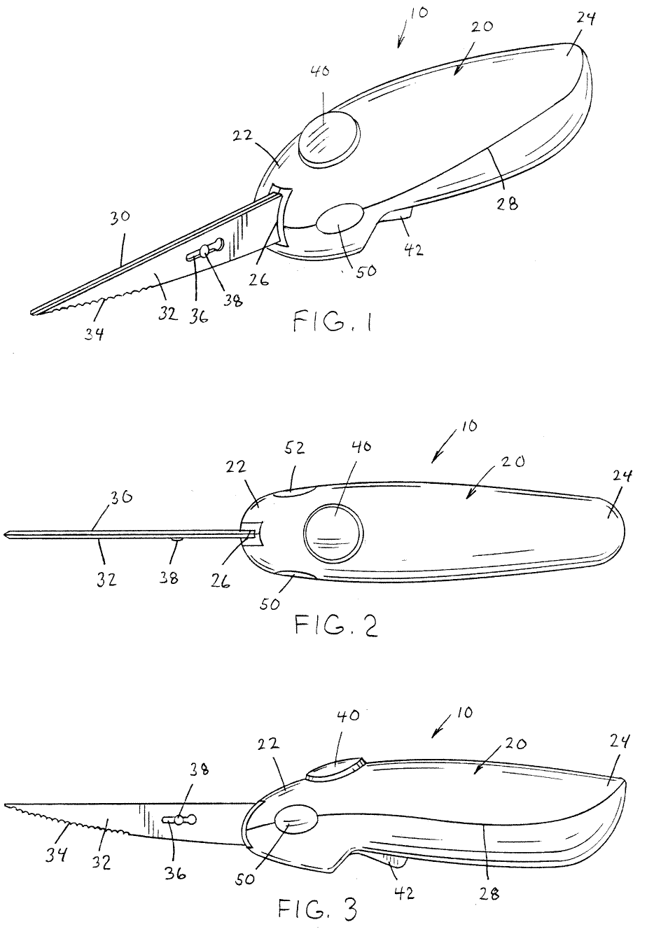

Referring now to the drawings wherein the showings are for the purpose of illustrating a preferred embodiment of the invention only and not for the purpose of limiting same, FIGS. 1-3 illustrate one non-limiting battery powered knife 10 in accordance with the present invention. The knife 10 includes a body or handle 20. The shape of the handle is non-limiting. Generally the shape of the handle has an ergonomic configuration that enables the handle to be easily gripped and maneuvered when using the knife; however, this is not required. The handle is generally made of light weight and durable materials (e.g., plastic, composite material, aluminum, etc.); however, this is not required. The handle has a front portion 22 and a rear portion 24. The handle can be formed of two pieces of material which come together at seal 28; however, this is not required. The front portion of the handle includes a blade opening 26 that is designed to received knife blades 30, 32. The knife blades 30, 32 each have serrated edges 34 at least partially along the length of the knife blades; however, this is not required. The knife blades can include a connection arrangement that maintains the two blades together and also allows the blades to reciprocate relative to one another: however, this is not required. As illustrated in FIG. 1, knife blade 32 includes a slot 36 that allows a pin 38 to side along the length of the slot while the two blades reciprocate. As can be appreciated, many other or additional arrangements can be used for the connection arrangement between the two knife blades. The longitudinal alignment of the blades 30, 32 can be selectably offset; however, this is not required.

The handle also includes two switches 40, 42 that are used to activate and deactivate the motor inside the handle. Switch 40 is a safety switch that is required to be depressed prior to trigger switch 42 being able to be depressed for activation of the motor. As can be appreciated, switch 40 can be designed to activate the motor without use of trigger switch 42. Such an arrangement is illustrated in the knife of FIGS. 7-9 which will be discussed in more detail below. Likewise, trigger switch 42 can be used without the need of switch 40. As can be appreciated, many different switch/trigger arrangements can be used to activate the motor and/or to provide one or more safety systems for preventing inadvertent activation of the motor. The location of switches 40, 42 on handle 20 and/or the type of switches used on knife 10 is non-limiting.

The handle is illustrated as including two blade release buttons 50, 52. The two blade release buttons are located on each side of the handle of the knife. The blade release buttons are not required. As can be appreciated, a single button blade release can be used to release the two blades; however, this is not required. One non-limiting arrangement for a single blade release is illustrated in the knife of FIGS. 7-9 which will be discussed in more detail below. Referring again to FIGS. 1-3, the one or more blade release buttons, when used, enable the knife blades 30, 32 to be connected to and/or disengaged from handle 20. As can be appreciated, may other blade connection/release arrangements can be used on the knife. Furthermore, it will be appreciated that the location of the one or more blade release buttons on the handle is non-limiting.

The inner cavity of the handle includes one or more batteries, not shown, and at least one electric motor M. The one or more batteries are typically located at the rear portion 24 of the handle; however, this is not required. The inner cavity of the handle can include a separate battery compartment for holding one or more batteries; however, this is not required. The batteries used to power the electric motor of the knife are generally standard household batteries (e.g., AAA, AA, A, 9V, etc.); however, nonstandard batteries can be used. The one or more batteries used may or may not be rechargeable batteries. If one or more rechargeable batteries are used, the handle can include a connector to enable a power source to be connected to the one or more batteries in the handle to recharge the one or more batteries; however, this is not required. When the batteries are positioned on the handle, the handle can be designed to form a watertight environment for the batteries; however, this is not required.

The inner cavity located at the front portion of the handle generally includes a battery-powered motor M and a gear arrangement G. The electric motor M and the gear arrangement G are used to cause knife blades 30, 32 to reciprocate relative to one another. Many different types of motors M and/or gear arrangements G can be used. The motor M is selected to provide the desired speed and torque to cause knife blades 30, 32 to reciprocate at the desired speed and force through various types of food. The motor M and other components in the handle that are susceptible to damage by water or other liquids can be protected in the handle by a watertight arrangement; however, this is not required.

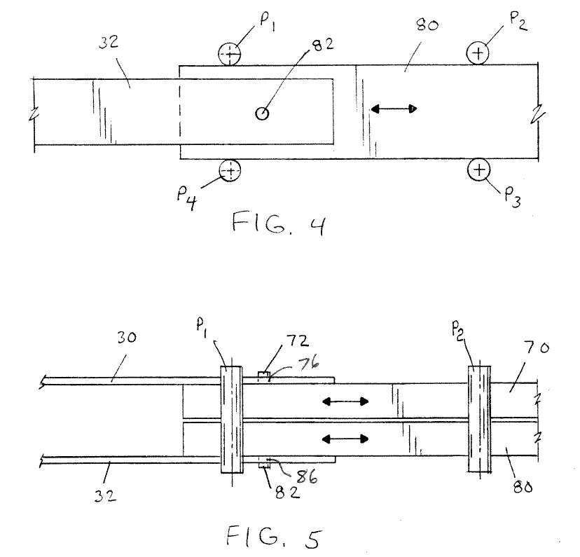

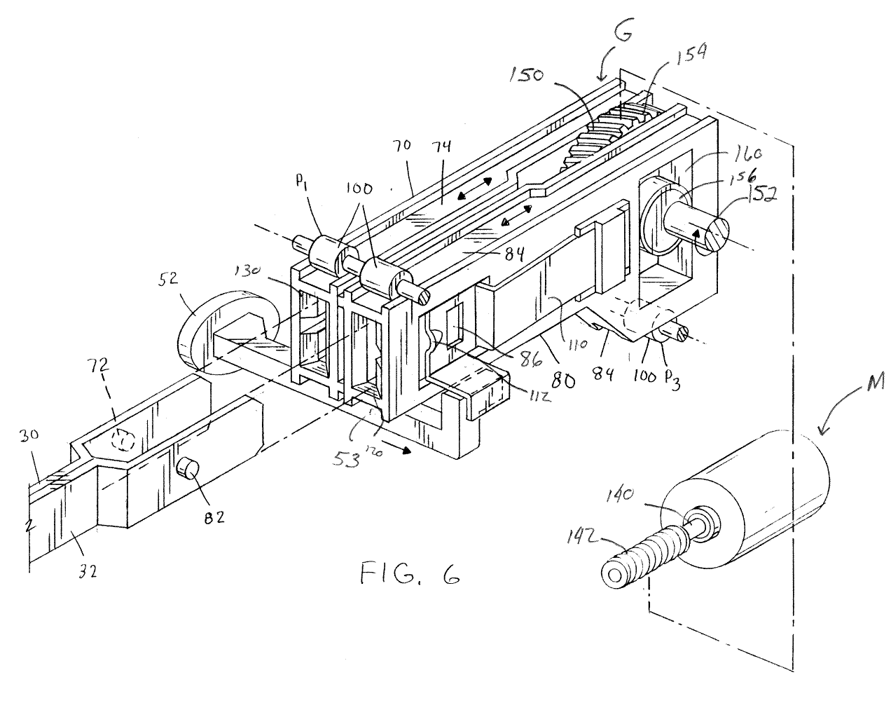

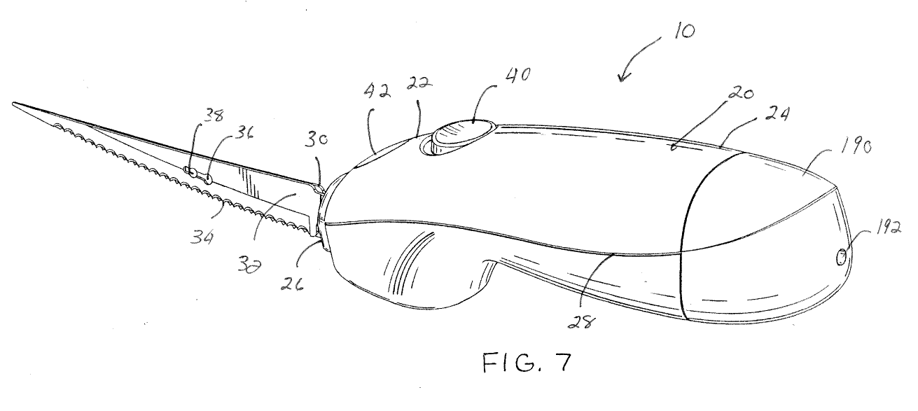

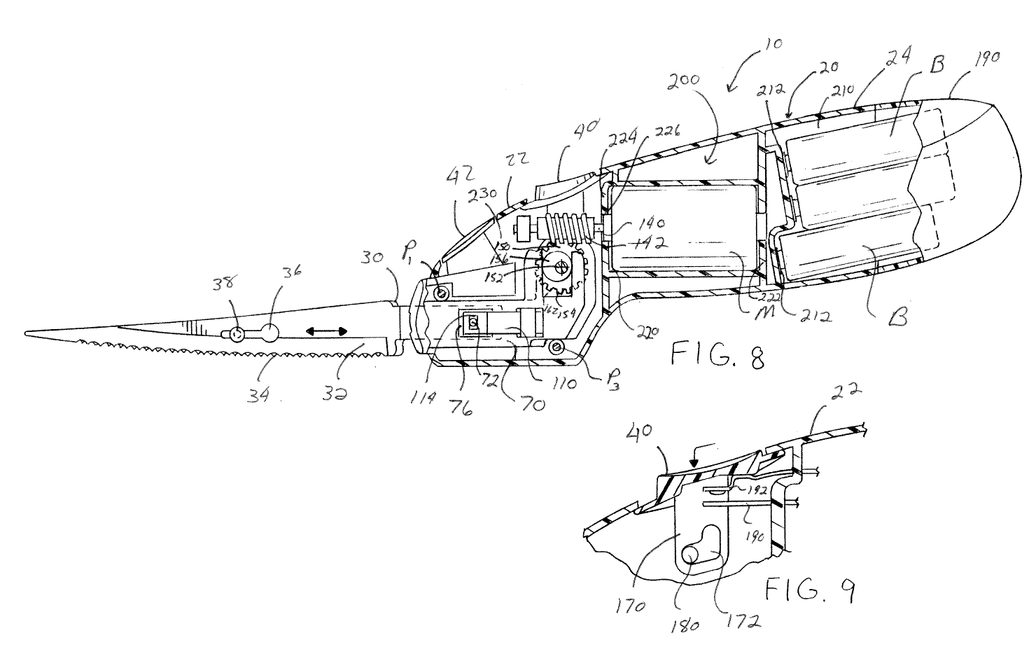

The knife generally includes a blade stabilization arrangement that is used to facilitate in the movement of the knife blades. The knife blades can be directly connected to a gear arrangement that is used to cause the blades to reciprocate, or be connected to blade mounts which in turn are connected to a gear arrangement that causes the blade mounts to reciprocate. As can be appreciated, many arrangements can be used to connect the knife blades to the handle and/or cause the knife blades to reciprocate when the motor is energized. Referring now to FIGS. 4 and 5, there is illustrated two blade mounts 70, 80. The blade mounts are designed to be connected to knife blades 30, 32. The blade mounts include a pin openings 76, 86 that are designed to receive pins 72, 82 in blades 30, 32. The pins in the blades are used to secure the knife blades to the blade mounts. Four rotating pins P₁, P₂, P₃, P₄ are used to guide the blade mounts when the blade mounts reciprocate while the motor is energized. As can be appreciated, less than four pins or more than four pins can be used to guide the blade mounts when the blade mounts reciprocate while the motor is energized. As can also be appreciated, one or more of the pins can be designed to not rotate; however, when more than one pin is used, at least one pin is designed to rotate.

Referring now to FIG. 6, another and more detailed illustration of another blade stabilization arrangement is shown. The blade mounts include slots 120, 130 that are designed to telescopically receive an end portion of the blades 30, 32, respectively. The inclusion of the slots facilitates in securing and stabilizing the blades in the blade mounts. As can be appreciated, the use of slots 120, 130 in the blade mounts is not required. The blade mounts 70, 80 can include grooves 74, 84 on the top and/or bottom surfaces of the blade mounts. The use of grooves in one or both of the blade mounts in not required. These grooves are designed to receive at least a portion of rollers 100 on pins P₁ and/or P₃. As can be appreciated, more than two rollers can be positioned on one or both pins. In this particular arrangement, pins P₂ and P₄ are not used. As can be appreciated, pins P₂ and/or P₄ can be used in this arrangement. As can also be appreciated, other slot arrangements can be used. The one or more slots in the blade mounts, when used, facilitate in guiding the movement of the blade mounts when the blade mounts move back and forth during the operation of motor M. The use of rollers 100 on the pins facilitates in reducing friction on the blade mounts during the movement of the blade mounts. As can be appreciated, pins P₁ and/or P₃ does not require the use of a roller. As also can be appreciated, when pins P₂ and/or P₄ are used, one or both pins may or may not include one or more rollers. As illustrated in FIG. 6, the slots in the top of the blade mounts are generally position at the front portion of the blade mounts; however, the slots can continue along the length of the blade mounts. The width of the slot on the top of the blade mounts is illustrating as varying; however, this is not required. The slots on the bottom of the blade mounts are generally position at the rear portion of the blade mounts; however, the slots can continue along the length of the blade mounts. The plane the slots exist in the bottom side of the blade mount at the rear portion of the blade mount is in a different plane from the bottom side of the front portion of the blade mount; however, this is not required.

Another non-limiting arrangement is illustrated for securing and detaching the knife blades to the blade mounts in FIG. 6. In this arrangement, a single button 52 is used to enable blades 30, 32 to be detached from blade mounts 70, 80. Button 52 is connected to an arm 53. The end of arm 53 engages a moveable clip 110 that is secured on the side of each blade mount. When button 52 is depressed, arm 53 causes a portion of clip 110 to move outwardly from the blade mount until pin openings 76, 86 move off of pins 72, 82 on the knife blades. Once the pin openings are moved off of pins 72, 82, the knife blades can be removed from the blade mounts. As illustrated in FIG. 6, a portion of clip 110 includes a dented portion 112 that enables the knife blades to be secured to the blade mounts without having to press button 52. The inclusion of the dented portions in the clips is not required. As can be appreciated, many other arrangements can be used to secure and/or release one or both blades from the blade mounts.

FIG. 6 illustrates a non-limiting arrangement for a gear arrangement G and motor M that is used to cause the blade mounts to reciprocate when the motor is energized. As discussed above, motor M is an electric motor that is powered by one or more batteries. As illustrated in FIG. 6, the front end of motor M includes a rotating shaft 140 and includes a threaded portion 142 at the end of the shaft. The size of the motor is selected to generate the desired power necessary to cause the knife blades to reciprocate the desired speed. The threaded end of the motor shaft is designed to engage gear 150 in the gear arrangement G. Gear 150 is rotatably connected in the interior of the handle, not shown. Gear 150 includes a shaft 152 passing through the central axis of the gear. The gear includes a plurality of teeth 154 that are designed to engage the thread on the motor shaft. Positioned on both sides on gear 150 are two off-center cylinders 156 that are designed to convert the rotational motion of gear 150 into a linear motion for the two blade mounts. As illustrated in FIG. 6, the blade mounts have a generally L-shape and wherein the rear portion of the blade mounts include a cam opening 160 that is designed to receive a portion of the cylinder 154 as can be appreciated, the blade mounts can have other shapes. The cam openings have a generally polygonal shape (e.g., rectangular, square, etc.); however, other shapes can be used. As can be understood for the arrangement illustrated in FIG. 6, when motor M is energized, the motor shaft 140 rotates. The rotation of the motor shaft causes the thread at the end of the shaft to also rotate. The engagement of the thread 142 with the teeth 154 in gear 150 causes the gear to rotate as illustrated by the arrow in FIG. 6, when gear 150 rotates, the two off-center cylinders 156 move within the cam openings in the blade mounts 70, 80 thereby causing the blade mounts to move forward and backwards. The two off-center cylinders 156 can be oriented on gear 150 such that the two off-center cylinders 156 cause the two blade mounts to reciprocate relative to one another as illustrated by the arrows. The reciprocation of the two blade mounts in turn causes the two blades 30, 32 to reciprocate. The rollers 100 on the pins are at least partially positioned in grooves 74, 84 on the top and/or bottom surfaces of the blade mounts so as to guide the movement of the blade mounts, to facilitate in the movement of the blade mounts, and to reduce the friction of movement of the blade mounts.

Referring now to FIGS. 7-9, another non-limiting configuration of the battery powered knife 10 in accordance with the present invention. The knife 10 includes a body or handle 20. The shape of the handle is non-limiting. Generally the shape of the handle has an ergonomic configuration that enables the handle to be easily gripped and maneuvered when using the knife; however, this is not required. The handle is generally made of light weight and durable materials; however, this is not required. The handle has a front portion 22 and a rear portion 24. The handle can be formed of two pieces of material which come together at seal 28; however, this is not required. The front portion of the handle includes a blade opening 26 that is designed to received knife blades 30, 32. The knife blades 30, 32 each have serrated edges 34 at least partially along the length of the knife blades; however, this is not required. The knife blades can include a connection arrangement that maintains the two blades together and also allows the blades to reciprocate relative to one another; however, this is not required. As illustrated in FIG. 7, knife blade 32 includes a slot 36 that allows a pin 38 to side along the length of the slot while the two blades reciprocate. As can be appreciated, many other or additional arrangements can be used for the connection arrangement between the two knife blades. The longitudinal alignment of the blades 30, 32 can be selectably offset; however, this is not required.

The handle also includes two depressable buttons 40, 42 located on the top of the handle. Button 40 is used to activate and deactivate the motor inside the handle. Switch 40 is a safety switch that is designed to prevent inadvertent activation of the motor M in side the handle; however, this is not required. As illustrated in FIG. 9, button 40 is designed to be pushed forward and then pushed downward to cause motor M to be activated. The opening of button 40 in the front portion of the handle is thus designed to enable button 40 to be pushed slightly forward. Connected to the base of button 40 is a flange 170 that includes a generally L-shaped slot 172; however, this is not required. Slot 172 is designed to receive a pin 180 that is located inside the handle of the knife. The shape of the slot is such that the button 40 needs to be moved slightly forward by a user and then pushed downwardly by the user to cause the button to bring at least one of the two electrical contacts 190, 192 into contact with one another and thereby cause the motor M to be energized. Button 40 generally works with a spring, not shown, to cause button 40 to move back into its original position as illustrated in FIG. 9 when the user releases the button; thereby causing the electrical contacts to separate from one another and cause the motor to stop. As can be appreciated, the knife 10 can include other or additional safety arrangements to control the operation of the knife. As can be appreciated, many different arrangements can be used to activate the motor and/or to provide one or more safety systems for preventing inadvertent activation of the motor. The location of button 40 on handle 20 and/or the type of electrical activation arrangement used with the button on knife 10 is non-limiting.

The handle is illustrated as including one blade release button 42. The blade release button is located on the top of the handle of the knife. The blade release button is not required. As can be appreciated, more than one blade release button can be used to release the two knifes; however, this is not required. The blade release button, when used, enables the knife blades 30, 32 to be connected to and/or disengaged from handle 20. As can be appreciated, may other blade connection release arrangements can be used on the knife. Furthermore, it will be appreciated that the location of the blade release button on the handle is non-limiting.

The rear portion 24 of the handle can include a battery cap 190 that is designed to be removed by a user when inserting and/or removing batteries from the battery compartment in the handle. The battery cap can be designed to form a watertight seal for the battery compartment when the battery cap is secured to the handle; however, this is not required. In such an arrangement, one or more seals (e.g., rubber seal, elastomer seal, etc.) and/or a sealing arrangement (e.g., groove arrangement, etc.) can be used to facilitate in forming the watertight seal; however, this is not required. The battery cap can be designed to be snapped on/off the handle for easy access to the batteries; however, it can be appreciated that one or more screws, clips, etc. can be used to secure the battery cap to the rear portion of the handle. The back of the battery cap includes an opening 192 that can be used to connect a power cord to the knife to power the motor and/or to recharge the batteries in the handle of the knife. The use of a power cord with the knife is optional.

Referring now to FIG. 8, an interior cross-section of the knife of FIG. 7 is illustrated. As can be appreciated, one or more components of the knife illustrated in FIG. 8 can similarly be used and/or positioned in the handle of the knife of FIG. 1; however, this is not required. The inner cavity 200 of the handle 20 includes one or more batteries B and at least one electric motor M. The one or more batteries are located in a battery compartment 210 that is located in the rear portion of the handle. As illustrated in FIG. 8, the battery compartment is designed to hold a plurality of batteries; however, this is not required. The batteries used to power the electric motor of the knife are generally standard household batteries; however, nonstandard batteries can be used. The one or more batteries used may or may not be rechargeable batteries. If one or more rechargeable batteries are used, the handle can include a connector via opening 192 to enable a power source to be connected to the one or more batteries in the handle to recharge the one or more batteries; however, this is not required. As mentioned above, the battery compartment is generally designed to form a watertight seal when the battery cap 190 is secured to the handle; however, this is not required. The battery component includes one or more electric connectors 212 that enable current to flow from the batteries to motor M.

Positioned adjacent to the battery compartment 210 is a motor compartment 220 that is designed to hold motor M. The motor compartment generally forms a watertight seal for motor M; however, this is not required. A watertight seal can exist between the battery compartment and the motor compartment; however, this is not required. As illustrated in FIG. 8, the battery compartment includes a rear wall 222 that at least partially divides the motor compartment from the battery compartment. Wall 222 can at least partially form a watertight seal between the battery compartment and the motor compartment and/or provide structural integrity to the handle of the knife; however, this is not required. Battery compartment 220 also includes a front wall 224 that at least partially divides the motor compartment from the gear compartment 230. Wall 224 can at least partially form a watertight seal between the battery compartment and the gear compartment and/or provide structural integrity to the handle of the knife; however, this is not required. The front wall 224 includes an opening 226 that enable the shaft 140 of the motor to extend into the gear compartment. A seal can be positioned about shaft 140 in or about opening 226 so as to form a watertight seal; however, this is not required.

Positioned in the gear compartment is a gear arrangement. The electric motor M and the gear arrangement G are used to cause knife blades 30, 32 to reciprocate relative to one another. Many different types of motors M and/or gear arrangements G can be used. The motor M is selected to provide the desired speed and torque to cause knife blades 30, 32 to reciprocate at the desired speed and force through various types of food and/or other objects. The gear compartment can include a watertight arrangement; however, this is not required. A watertight seal can exist between the battery compartment and the gear compartment; however, this is not required.

The knife generally includes a blade stabilization arrangement that is used to facilitate in the movement of the knife blades. The knife blades can be directly connected to the gear arrangement that is used to cause the blades to reciprocate, or be connected to blade mounts which in turn are connected to a gear arrangement that causes the blade mounts to reciprocate. As can be appreciated, many arrangements can be used to connect the knife blades to the handle and/or cause the knife blades to reciprocate when the motor is energized. Referring again to FIG. 8, there is illustrated a blade mount 70 for each blade. The second blade mount is not shown in FIG. 8. The blade mount 70 is designed to be connected to the knife blade 32 and the not shown blade mount is designed to be connected to knife blade 30. The two blade mounts have a similar configuration; however, this is not required. The configuration of blade mount 70 will now be described. Blade mount 70 includes a pin opening 76 that is designed to receive pin 72 in blade 32. The pin in blade 32 is used to secure the knife blade to blade mount 70. A moveable clip 110 is secured on the side of each blade mount. A portion of clip 110 is designed to move outwardly when button 42 is depressed. When button 42 is depressed by a user, the front portion of clip 110 moves off from the blade mount until an opening 114 in the clip 110 moves off of pin 72 on the knife blade. Once opening 114 moves off of pin 72, the knife blade can be removed from the blade mount. Although not shown, a portion of clip 110 can include a dented portion that enables the knife blade to be secured to the blade mount without having to press button 42; however, this is not required. The location and/or shape of the dented portion can be the same or similar to dented portion 112 illustrated in FIG. 6; however, this is not required. As mentioned above, the other blade mount that is not illustrated in FIG. 8 can have the same or similar structures and/or configurations as blade mount 70.

As illustrated in FIG. 8, two rotating pins P₁ and P₃4 are used to guide the blade mounts when the blade mounts reciprocate while the motor is energized. As can be appreciated, more than two pins can be used to guide the blade mounts when the blade mounts reciprocate while the motor is energized. As can also be appreciated, one or more of the pins can be designed to not rotate; however, when more than one pin is used, at least one pin is designed to rotate. The blade stabilization arrangement can be the same as or similar to the blade stabilization arrangement illustrated in FIGS. 4-6 as described in detail above.

FIG. 8 illustrates a non-limiting arrangement for a gear arrangement and motor M that is used to cause the blade mounts to reciprocate when the motor is energized. As discussed above, motor M is an electric motor that is powered by one or more batteries. As illustrated in FIG. 8, the front end of motor M includes a rotating shaft 140 and includes a threaded portion 142 at the end of the shaft. The size of the motor is selected to generate the desired power necessary to cause the knife blades to reciprocate the desired speed. The threaded end of the motor shaft is designed to engage gear 150 in the gear arrangement. Gear 150 is rotatably connected to the body of the handle. Gear 150 includes a shaft 152 passing through the central axis of the gear. The gear includes a plurality of teeth 154 that are designed to engage the thread on the motor shaft. Positioned on both sides on gear 150 are two off-center cylinders 156 that are designed to convert the rotational motion of gear 150 into a linear motion for the two blade mounts. As illustrated in FIG. 8, the blade mounts have a generally L-shape and wherein the rear portion of the blade mounts include a cam slot 162 that is designed to receive a portion of the cylinder 154. As can be appreciated, the blade mounts can have other shapes. The cam slot has a generally U-shape; however, other shapes can be used. As can be understood for the arrangement illustrated in FIG. 8, when motor M is energized, the motor shaft 140 rotates. The rotation of the motor shaft causes the thread at the end of the shaft to also rotate. The engagement of the thread 142 with the teeth 154 in gear 150 causes the gear to rotate. When gear 150 rotates, the two off-center cylinders 156 move within the cam slot in the two blade mounts thereby causing the blade mounts to move forward and backwards. The two off-center cylinders 156 can be oriented on gear 150 such that the two off-center cylinders 156 cause the two blade mounts to reciprocate relative to one another. The reciprocation of the two blade mounts in turn causes the two blades 30, 32 to reciprocate as illustrated by the arrows. The pins P₁ and P₃ facilitate in the movement of the blade mounts and reduce the friction of movement of the blade mounts.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

1-47. (canceled)

48. A battery powered knife comprising a handle having front and rear portions and an inner cavity, a power source located at least partially in the handle, an electric motor located at least partially in the handle, at least one activation switch designed to cause current from said power source to flow to said motor so as to energize said motor, at least one blade connectable to a front portion of said handle, a gear arrangement designed to cause said at least one blade to reciprocate when said motor is energized, and a blade stabilization arrangement that engages said at least one blade or a blade mount for said at least one blade, said blade stabilization arrangement designed to reduce friction of movement of said at least one blade or said blade mount when said motor is energized, said blade stabilization arrangement including at least one rotating element.

49. The battery powered knife as defined in claim 48, wherein said blade stabilization arrangement includes a plurality of rotating pins.

50. The battery powered knife as defined in claim 48, wherein said blade stabilization arrangement includes at least one pin that includes at least one roller.

51. The battery powered knife as defined in claim 48, wherein said at least one blade mount includes at least one guide slot designed to engage at least a portion of said blade stabilization arrangement.

52. The battery powered knife as defined in claim 50, wherein said at least one blade mount includes at least one guide slot designed to engage at least a portion of said blade stabilization arrangement.

53. The battery powered knife as defined in claim 48, including two blade mounts designed to engage or interengage with said gear arrangement, each of said blade mounts connectable to at least one of said blades.

54. The battery powered knife as defined in claim 48, wherein each of said blade mounts includes at least one guide slot designed to engage at least a portion of said blade stabilization arrangement.

55. The battery powered knife as defined in claim 52, wherein each of said blade mounts includes at least one guide slot designed to engage at least a portion of said blade stabilization arrangement.

56. The battery powered knife as defined in claim 48, wherein said at least one blade mount includes a blade cavity designed to telescopically receive a portion of a rear end of a blade.

57. The battery powered knife as defined in claim 48, wherein said at least one blade mount includes blade connector designed to releasably connect said blade to said blade mount.

58. The battery powered knife as defined in claim 48, including a safety switch arrangement to control energization of said motor.

59. The battery powered knife as defined in claim 48, including a water sealing arrangement designed to at least partially waterproof said power source, said electric motor, said gear arrangement, said activation switch, said blade stabilization arrangement, and combinations thereof.

60. The battery powered knife as defined in claim 55, including a water sealing arrangement designed to at least partially waterproof said power source, said electric motor, said gear arrangement, said activation switch, said blade stabilization arrangement, and combinations thereof

61. A battery powered knife comprising a handle having front and rear portions and an inner cavity, a power source located at least partially in the handle, an electric motor located at least partially in the handle, at least one activation switch designed to cause current from said power source to flow to said motor so as to energize said motor, at least one blade connectable to a front portion of said handle, a gear arrangement designed to cause said at least one blade to reciprocate when said motor is energized, and a water sealing arrangement designed to at least partially waterproof said power source, said electric motor, said gear arrangement, said activation switch, and combinations thereof, said water sealing arrangement includes at least one seal.

62. The battery powered knife as defined in claim 61, wherein said water sealing arrangement substantially waterproofs said power source, said electric motor, and other electrical components in said handle.

63. The battery powered knife as defined in claim 61, including a blade stabilization arrangement that engages said at least one blade or a blade mount for said at least one blade, said blade stabilization arrangement designed to reduce friction of movement of said at least one blade or said blade mount when said motor is energized, said blade stabilization arrangement includes at least one rotating element, said at least one rotating element including an element selected from the group consisting of a rotating pin, a pin that includes at least one roller, and combinations thereof.

64. The battery powered knife as defined in claim 62, including a blade stabilization arrangement that engages said at least one blade or a blade mount for said at least one blade, said blade stabilization arrangement designed to reduce friction of movement of said at least one blade or said blade mount when said motor is energized, said blade stabilization arrangement includes at least one rotating element, said at least one rotating element including an element selected from the group consisting of a rotating pin, a pin that includes at least one roller, and combinations thereof.

65. The battery powered knife as defined in claim 63, wherein at least one of said blade mounts includes at least one guide slot designed to engage at least a portion of said blade stabilization arrangement.

66. The battery powered knife as defined in claim 64, wherein at least one of said blade mounts includes at least one guide slot designed to engage at least a portion of said blade stabilization arrangement.
